(19) United States
(12) Patent Application Publication
(10) Pub. No.: US 2010/0073330 A1
(43) Pub. Date: Mar. 25, 2010

(54) Methods and Devices Relating To Transfer of Non-Pen Stroke Data

(76) Inventors: Petter Ericson, Malmo (SE); Stefan Lynggaard, Lund (SE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/922,692

(22) PCT Filed: Jun. 22, 2006
(86) PCT No.: PCT/SE2006/000772

§ 371 Date: Dec. 21, 2007

Related U.S. Application Data
(60) Provisional application No. 60/693,045, filed on Jun. 23, 2005.

(30) Foreign Application Priority Data
Jun. 23, 2005 (SE) 0501483-2

(51) Int. Cl. G06F 3/033

(52) U.S. Cl. 345/179

(57) ABSTRACT

Non-pen stroke data, e.g. barcode data or keyboard data, can be transferred through a transfer system which is formatted specifically for the transfer of pen stroke data, by coding the non-pen stroke data as pen stroke data. The non-pen stroke data may particularly be coded as pen strokes in a position area which is not used for the transfer of ordinary pen strokes, e.g. a margin area.

### CROSS-REFERENCE TO RELATED APPLICATIONS

The present application claims the benefit of Swedish patent application no. 0501483-2, filed on Jun. 23, 2005 and U.S. provisional patent application No. 60/693,045, filed on Jun. 23, 2005, both of which are hereby incorporated by reference.

### FIELD OF THE INVENTION

The present invention generally relates to the transfer of non-pen stroke data in a transfer system designed for the transfer of pen stroke data. More particularly the invention relates to a method and a device at the sender side of such a transfer system and a method and a device at the receiver side of such transfer system.

### BACKGROUND ART

Information management systems are known where handwritten information is electronically recorded from a position-coded base by means of an electronic pen and subsequently transferred to an application in a local or remote unit for further processing, see e.g. US 2003/0061188; US 2003/0046256 and US 2002/0081711.

In these information management systems, the position code on each base is a subset of a much larger abstract position code. Different parts of this overall position code may be dedicated to different units. By providing different bases with different subsets of the position code, handwritten information can be automatically sent from the pen to the correct receiving unit.

US 2003/0055865 shows a system for transferring handwritten information in the form of pen stroke data recorded by an electronic pen from a position-coded base to an application. In this system, the electronic pen in a first roundtrip establishes contact with a so-called paper lookup server (PLS) and asks for routing information based upon position data that the pen derived from the position-coded base. Then, upon receipt of the routing information from the PLS, the electronic pen in a second roundtrip establishes contact with an application server as indicated by the routing information. The application server then requests the relevant pen stroke data from the pen.

Thus, the handwritten information is transferred to the application server in the form of pen strokes. Each pen stroke is represented by a sequence of positions, which reflects the pen movement over the base.

One embodiment of the above system has been implemented by Anoto AB, Sweden and used for commercial applications by third parties. In this embodiment, communication between the pen, the PLS and the application server is carried out according to a proprietary Pen Protocol defined by Anoto AB. The system is furthermore specifically designed for transfer of pen stroke data in the form of position indications. The pen strokes are e.g. transferred according to a proprietary Stroke Transport Format also defined by Anoto AB.

It has previously been proposed that an electronic pen used in an information management system of the above-described type could record non-pen stroke data, e.g. barcodes and other kinds of information codes, see e.g. US 2002/0050982 and US 2001/0038349, which are hereby incorporated by reference. The above-mentioned transfer system is however not formatted for transfer of such data. One way of solving this problem would be to change the Pen Protocol and/or the Stroke Transport Format to allow for the transfer of non-pen stroke data. However, such a solution may e.g. result in compatibility problems.

### SUMMARY OF THE INVENTION

One object of the present invention is thus to enable transfer of non-pen stroke data in a transfer system designed for the transfer of pen stroke data.

This object is partly or wholly achieved by a method and a device at the sender side of the transfer system and a method and a device at the receiver side of the transfer system as claimed in the independent claims.

According to one aspect of the invention, a method at the sender side of a transfer system designed for the transfer of pen stroke data, comprises receiving non-pen stroke data; and coding the non-pen stroke data as pen stroke data using a predetermined reversible coding process before transferring the pen-stroke coded non-pen stroke data via the transfer system to a receiving unit.

By coding non-pen stroke data as pen stroke data, non-pen stroke data can be transferred via a transfer system designed for the transfer of pen stroke data without having to amend the transfer format. A transfer system designed for the transfer of pen stroke data should here be taken to mean a predetermined way to send pen stroke data from a sender to a receiver, such as through a predetermined format or predetermined protocol.

If both pen stroke data and pen stroke-coded non-pen stroke data are sent through the transfer system to a receiving unit, the receiving unit may need to be able to distinguish non-pen stroke data from pen stroke data. This can be achieved by providing the non-pen stroke data with a distinguishing characteristic.

If e.g. the pen stroke data is transferred in the form of position indications a characteristic distinguishing non-pen stroke data from pen stroke data could be the respective position area to which the position indications representing the different kinds of data belong. Non-pen stroke data may e.g. be coded as positions belonging to a predetermined position area dedicated to pen stroke-coded non-pen stroke data.

This predetermined position area may be a position area which is invalid for pen strokes made by an electronic pen. The area may be invalid for different reasons. It may e.g. be invalid because it is an area which is never to be printed on any base so that a user may not make any physical pen strokes on such an area. It may as another example be invalid because a component of the information system has designated it as an invalid area from which pen strokes are never to be used.

The coding of non-pen stroke data as pen stroke data may take place in an electronic pen, which is configured to record pen stroke data in the form of position indications from a position-coded base and to record non-pen stroke data from the same or another base. It may alternatively take place in another unit at the sender side, e.g. a mobile phone or PDA. The pen stroke-coded non-pen stroke data may then be sent directly through the transfer system or merged with pen stroke data in the unit itself or in another unit.

The non-pen stroke data may e.g. be barcode data from one or more barcodes or data from other standardized or proprietary information codes, such as for instance data from the codes described in WO2006/001769, keyboard data, ICR data, gesture data, or data concerning use of the pen, e.g. the angle at which it was held when recording certain information.

The non-pen stroke data may furthermore be received at the sender side in any format. Depending on the format, the data may need to be converted before being coded to pen-stroke data.

In the coding process, account may have to be taken to any compression or data reduction process comprised in the transfer system so that non-pen stroke data is losslessly transferred through the transfer system.

According to a further aspect of the invention, a device at the sender side of a transfer system designed for the transfer of pen stroke data to a receiving unit comprises a processing unit for carrying out the method.

The processing unit may comprise a signal-processing unit and memory operably coupled to the signal-processing unit which contains instructions causing the signal-processing unit to carry out the method at the sender side of the transfer system. Alternatively or as a supplement, the processing unit may comprise hardware, e.g. specifically adapted hardware circuitry, for partly or fully carrying out one or more of the steps of the method.

According to another aspect, a method at the receiving side of a transfer system designed for the transfer of pen stroke data comprises receiving pen stroke data from the transfer system; and decoding non-pen stroke data from the pen stroke data using a predetermined decoding process.

According to yet another aspect, a device at the receiver side of a transfer system designed for the transfer of pen stroke data comprises a processing unit adapted to carry out the method at the receiving side.

What is said above regarding the realization of the device at the sender side also applies for the device at the receiver side.

### BRIEF DESCRIPTION OF DRAWINGS

The invention will now be described more in detail by way of examples, reference being had to the accompanying schematic drawings.

FIG. 1 schematically shows an embodiment of an information management system;

FIG. 2 schematically shows four different locations of a coding symbol in an embodiment of a position code;

FIG. 3 is a schematic illustration of an embodiment of a part of a position code;

FIG. 4 schematically shows how a position code may be hierarchically subdivided;

FIG. 5 schematically shows an embodiment of an electronic pen; and

FIG. 6 schematically illustrates how non-pen stroke data may be coded in the margin of a pattern page.

### DETAILED DESCRIPTION OF EMBODIMENTS OF THE INVENTION

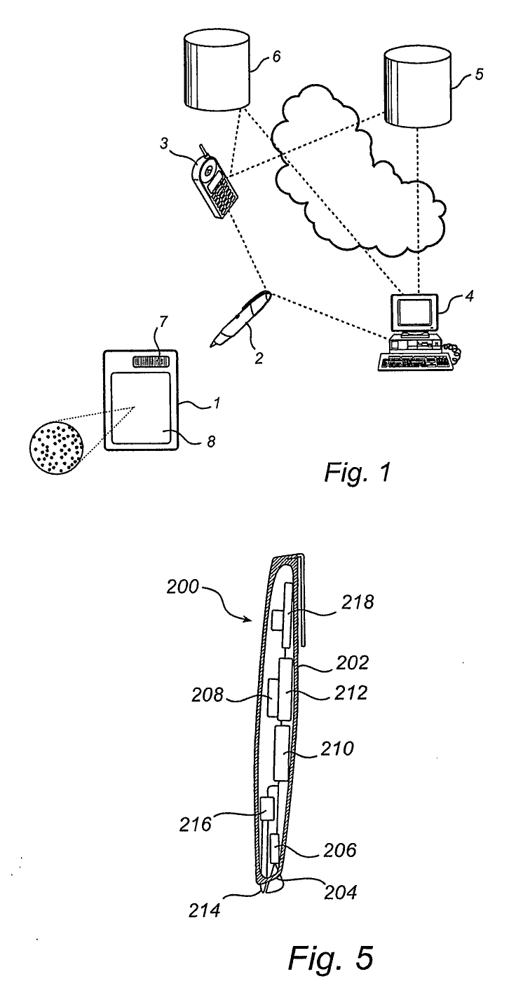

FIG. 1 shows an embodiment of an information management system which is designed to handle pen-stroke data. It comprises a base 1, an electronic pen 2, local units in the form of a mobile phone 3 and a personal computer (PC) 4, and remote units in the form of a look-up server 5 and an application server 6.

The base 1, which may be a paper or any other substrate which is suitable for being printed on, is provided with a position code 8, a small part of which is schematically shown in an enlarged scale. It is furthermore provided with non-position data in the form of a barcode 7.

The electronic pen 2, an embodiment of which will be described more in detail below with reference to FIG. 5, is capable of recording and decoding position information from the position code 8. The pen 2 may process the decoded information internally and provide feed-back to a user in response to the decoded information. It may alternatively or as a supplement communicate with a local or remote unit in order for that unit to take care of at least part of the processing of the recorded information and/or respond to the decoded information. The local units 3, 4 may also act as a communication interface to the remote units 5, 6 for forwarding of the recorded/decoded information.

The electronic pen 2 is also capable of recording and decoding the barcode 7. The recording of the position code 8 and the barcode 7 is carried out by means of one and the same sensor in the electronic pen 2. Alternatively, the recording of non-position data may be carried out by a separate sensor.

The pen 2 may work in a stand-alone mode, in which it buffers recorded pen strokes in its memory and sends them to a local or remote receiving unit when triggered to by the user, or a streaming mode, in which it more or less continuously sends recorded data to the receiving unit, or in any other appropriate mode.

The communication between the pen and the receiving unit may be two-way or one-way. An example of a two-way communication is shown in the above-mentioned US 2003/0055865. An example of a one-way communication is when the pen includes the recorded strokes in a file object, which is pushed to or otherwise exposed to an external unit, which may be a final destination unit or an intermediary unit. Such a system is shown e.g. in WO 2006/004505, which is hereby incorporated by reference.

The system illustrated in FIG. 1 is primarily designed for the management of handwritten information in the form of pen strokes. A pen stroke may be recorded as a sequence of spatially and temporally related positions. The pen may for instance be provided with a contact detector which detects when the pen is put down on the base and subsequently lifted from the base. The positions of the pen between a “pen-down” and the next “pen-up” may define a pen stroke.

The system may, however, also transfer e.g. pen parameters, which are stored in the pen, and stroke properties, that have been assigned to pen strokes, e.g. by the user having ticked one or more position areas dedicated to different pen stroke properties by the pen.

Even though the information management system of FIG. 1 is formatted for the transfer of pen stroke data, other data may be transferred transparently from the pen to a receiving unit by coding the non-pen stroke data to pen stroke data. The coding can be carried out according to an arbitrary function provided that the coding is reversible so that the non-pen stroke data can be recovered at the receiving side of the system. The pen stroke data is in this embodiment transferred as a sequence of positions. If the receiving side receives both non-position data and position data, it may need to be able to distinguish non-position data from position data representing pen strokes made by the electronic pen 2 on the base 1. This can be achieved by setting aside at least one specific range of positions for the transfer of non-position data and to carry out the coding so that the non-position data is always coded as one or more positions within this specific range.

Before a more detailed embodiment of the coding process is described, some other aspects of the system will be described more in detail to facilitate the understanding of the method for transferring non-pen stroke data.

Below follows an exemplifying description of a specific position code that can be used on the base for enabling the recording of handwritten information. The position code is of the kind described in U.S. Pat. No. 6,667,695, which is hereby incorporated by reference and to which reference can be made for further details.

The position code is based on a number sequence which below is referred to as a difference number sequence. This difference number sequence has the property that if one takes an arbitrary partial sequence of a predetermined length, for instance a partial sequence with five difference numbers, this partial sequence always has an unambiguously determined location in the difference number sequence. In other words, it appears only once in the difference number sequence and can thus be used for position determination. A sequence of maximal length having this property is sometimes called a DeBruijn sequence. More specifically, the difference number sequence “runs” along the x axis as well as along the y axis of the position code.

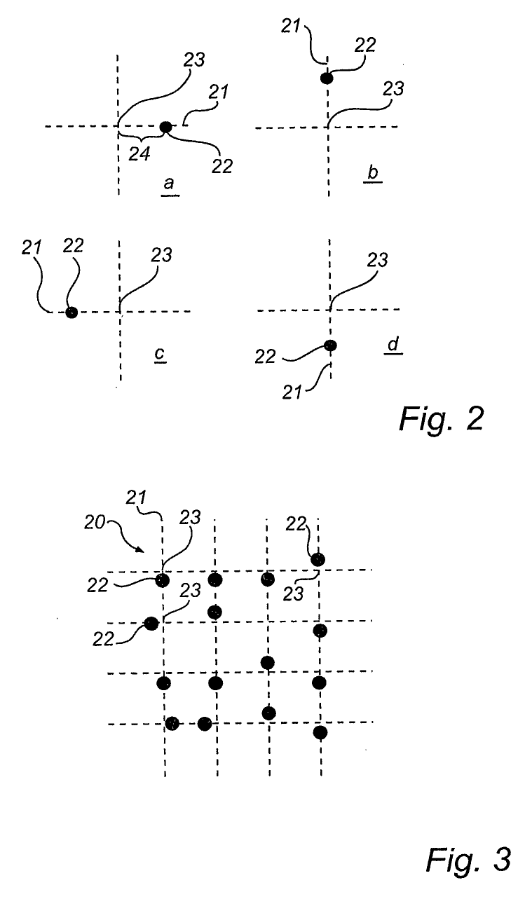

The actual position code as applied on a base is made up of simple graphical symbols or marks 22 which can assume four different values, 0-3, depending on their respective position in relation to a nominal position 23 or raster point. As seen in FIG. 2, each symbol 22 has the shape of a dot and is displaced a distance 24 in one of four different directions relative to the nominal position 23. The nominal position 23 is at an intersection between raster lines 21 in a visible or invisible or virtual raster or grid. The value coded by the symbol is determined by the direction of the displacement. Each symbol value 0-3 can be converted into one bit which is used for coding an x coordinate and one bit which is used for coding a y coordinate, i.e. into the pairs of bits (0,0), (0,1), (1,0), and (1,1). Thus, the coding is made separately in the x direction and the y direction, but the graphical coding is made with a symbol which is common to the x and y bits.

It should be mentioned that the coding may for instance be as follow:

| Displacement | Bit pair (x, y) |
|---|---|
| Right | 0, 1 |
| Up | 0, 0 |
| Left | 1, 0 |
| Down | 1, 1 |

The distance 24 is suitably not less than about ⅛ and not more than about ¼, preferably about ⅙, of the distance between two adjacent raster lines 21.

Each position is coded by 6*6 symbols which can thus be converted into a 6*6 bit matrix for an x coordinate and a 6*6 bit matrix for a y coordinate for the position. If the x bit matrix is considered, this can be divided into six columns of six bits each. Each sequence of bits in a column constitutes a partial sequence in a 63-bit-long cyclic main number sequence which has the property that if a partial sequence having a length of six bits is selected, this has an unambiguously determined place in the main number sequence. The six columns can thus be converted into six position numbers or sequence values which correspond to six places in the main number sequence. Between these six position numbers, five difference numbers can be formed in neighboring pairs, which constitute a partial sequence of the difference number sequence and which thus have an unambiguously determined place in the same and, consequently, an unambiguously determined place along the x axis. For a certain x coordinate, the position numbers will vary depending on the y coordinate. On the other hand, the difference numbers will be the same independently of the y coordinate, since the position numbers always vary according to the main number sequence, which is repeated cyclically in the columns in the entire position-coding pattern.

Correspondingly, six rows in the y bit matrix define six position numbers in the main number sequence. These six position numbers define five difference numbers, which constitute a partial sequence of the difference number sequence and which thus have an unambiguously determined place along the y axis.

FIG. 3 shows a very small part of the above-described exemplary position code with 4*4 symbols. The raster lines 21 are shown in the figure for illustration purposes only. In general, the raster is virtual.

When an electronic pen is used on the position code, it may capture images of different parts of the position code. The images may contain considerably more than 6*6 symbols. Thus the position code may be decoded based on different sets of 6*6 symbols if a larger number of symbols are visible in the image. Surrounding symbols may also be used in the decoding, inter alia, for error detection and/or correction. It should however be noted that even if the field of view of the electronic pen comprises a larger number of symbols than is strictly required for the decoding of a position, the number of useful symbols in the recorded image may be considerably smaller due to e.g. image distortion.

The above-described exemplary position code is of a so called “floating type”. It means that any arbitrary partial area comprising a predetermined number of symbols, here 6*6 symbols, will define a position and that at least some of the symbols in the arbitrary partial area contribute to the coding of more than one position. Otherwise stated, if the arbitrary partial area is moved a symbol distance up, down, to the left or to the right, a new position will be defined by the symbols in the arbitrary partial area thus moved. Thus, a unique x,y coordinate can be determined for each coding symbol in the position-coding pattern.

The above-described exemplary position code is capable of coding a very large number of unique absolute positions. The positions can be considered as jointly defining a huge imaginary surface or abstract position code. The area of the imaginary surface is much larger than the area of any practically conceivable base. The positions coded on a base are positions on this imaginary surface and the origin of the position coordinates is the origin of the imaginary surface. Also, each base is provided with only a small subset of the overall position code.

The imaginary surface or the abstract position code can be logically subdivided into pages of different sizes. Any unit, e.g. an electronic pen or a computer, having knowledge about the subdivision of the imaginary surface may thus convert a position on the imaginary surface recorded from a position-coded base to an indication of the corresponding page and a local position on that page. It is understood that a local position is expressed in a coordinate system having its origin somewhere on the page.

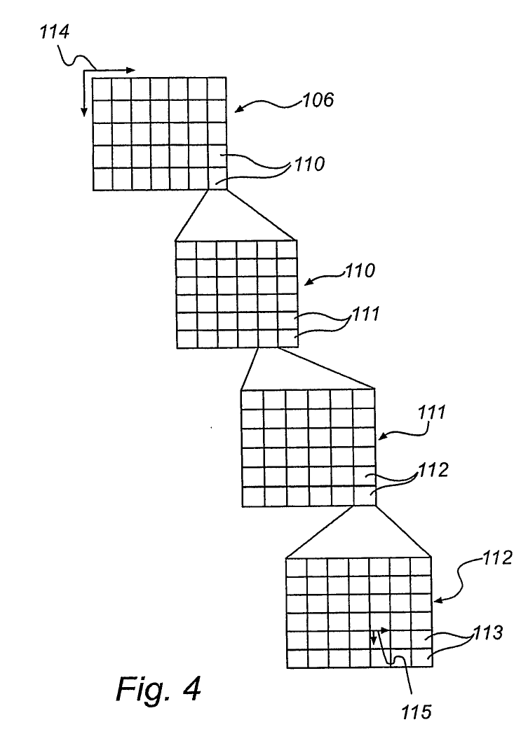

FIG. 4 shows an example, in which the pattern 106 contains “segments” 110 which in turn are divided into a number of “shelves” 111, each containing a number of “books” 112 which are divided into a number of aforesaid pages 113, also called “pattern pages”. Suitably, all pattern pages have the same format within one level of the above pattern hierarchy. For example, some shelves may consist of pattern pages in A4 format, while other consists of pattern pages in A5 format. The position of a certain pattern page in the abstract pattern can be noted as a page address of the form: segment.shelf.book.page, for instance 99.5000.1.1500, more or less like an IP address. For reasons of processing efficiency, the internal representation of the page address may be different, for example given as an integer of a predetermined length, e.g. 64 bits.

In one example, each segment consists of more than 26,000,000 pattern pages, each with a size of about 50×50 cm². In one embodiment, at least one such segment is divided into 5,175 shelves, each consisting of 2 books with 2,517 pages each.

Each pattern page may be regarded as an actual subset of the graphically coded position code, or as the absolute positions that are coded by the subset. Each such absolute position may be represented as a paper position, i.e. a global position in the coordinate system 114 of the overall pattern, or as logical position, i.e. a page address and a local position in a coordinate system 115 within a pattern page.

The pen strokes may be stored either as a sequence of paper positions (i.e. a global pen stroke) or as a page address and a sequence of local positions on the corresponding pattern page (i.e. an addressed pen stroke).

The functionality of the pen is at least partly controlled by the user operating the pen on a specific part of the position code. The pen may store different templates that define how the information that is recorded from different parts (functional areas) of the position code is to be interpreted. A specific subset in the page hierarchy, e.g. a segment or a shelf, may be associated with a given template definition, which thus is valid for all pattern pages within that specific subset. The template may define the size, placement and function of any functional areas that may affect the operation of the pen. The template may also define a margin around the entire pattern page, e.g. a 32 dot margin. The position code corresponding to the margin may not be printed on a base. Software tools used for preparing position-coded bases may for instance prevent printing of the position code corresponding to the margin. The function of the margin will be described more in detail below.

The above-described position code is just an example. Variants of this position code could also be used. The positions may e.g. be coded by other graphical symbols, such as dots of different sizes or differently rotated slashes. The number of symbols used for coding a position may be different. The code may also include other marks in addition to those used for position coding, such as marks used for finding the raster or finding the perspective or orientation. The coding principles may vary. The coding need not be floating. Instead the position code may include cells each of which codes a position by means of a plurality of symbols. In another position code each position is coded by a single more complex symbol.

Next a detailed example of an embodiment of the electronic pen 2 in FIG. 1 will be described with reference to FIG. 5.

The pen 200 has a pen-shaped casing or shell 202 that defines a window or opening 204, through which images are recorded. The casing contains a camera system, an electronics system and a power supply.

The camera system 206 comprises at least one illuminating light source, a lens arrangement and an optical image reader (not shown in the Figure). The light source, suitably a light-emitting diode (LED) or laser diode, illuminates a part of the area that can be viewed through the window 204, by means of infrared radiation. An image of the viewed area is projected on the image reader by means of the lens arrangement. The image reader may be a two-dimensional CCD or CMOS detector which is triggered to capture images at a flexible, adaptive or fixed rate, typically of about 70-100 Hz. Alternatively, the sensor may include a magnetic sensor array for detection of a magnetic property of the position code. Still further, the sensor may be designed to form an image of any chemical, acoustic, capacitive or inductive property of the position code.

The power supply for the digital pen is a battery 208, which alternatively can be replaced by or supplemented by mains power (not shown).

The electronics system comprises a control unit 210 which is connected to a memory block 212. The control unit 210 is responsible for the different functions in the pen and can advantageously be implemented by a commercially available microprocessor such as a CPU (“Central Processing Unit”), by a DSP (“Digital Signal Processor”) or by some other programmable logical device, such as an FPGA (“Field Programmable Gate Array”) or alternatively an ASIC (“Application-Specific Integrated Circuit”), discrete analog and digital components, or some combination of the above. The memory block 212 comprises preferably different types of memory, such as a working memory (e.g. a RAM) and a program code and persistent storage memory (a non-volatile memory, e.g. flash memory). Associated software is stored in the memory block 212 and is executed by the control unit 210. Instructions for the recording and decoding of non-pen stroke and pen stroke data and instructions for the coding of non-pen stroke data as pen stroke data may thus be stored in memory block 212 and executed by the control unit 210.

The casing 202 also carries a pen point 214 which allows the user to write or draw physically on a surface by an ordinary pigment-based marking ink being deposited thereon. The marking ink in the pen point 214 is suitably transparent to the illuminating radiation in order to avoid interference with the opto-electronic detection in the electronic pen. A contact sensor 216 is operatively connected to the pen point 214 to detect when the pen is applied to (pen down) and/or lifted from (pen up), and optionally to allow for determination of the application force. Based on the output of the contact sensor 216, the camera system 206 is controlled to capture images between a pen down and a pen up.

The electronics system further comprises a communications interface 218 for the communication of data to a nearby or remote apparatus such as a computer, mobile telephone, PDA, network server, etc. The communications interface 218 may thus provide components for wired or wireless short-range communication (e.g. USB, RS232, radio transmission, infrared transmission, ultrasound transmission, inductive coupling, etc), and/or components for wired or wireless remote communication, typically via a computer, telephone or satellite communications network.

The pen may also include an MMI (Man Machine Interface) which is selectively activated for user feedback. The MMI may include a display, an indicator lamp, a vibrator, a speaker, etc.

Still further, the pen may include one or more buttons 222 by means of which it can be activated and/or controlled.

In the embodiment of FIG. 5, the camera system 206 is slightly displaced from the pen point 214. The pen point will consequently not be in the same position as that coded by the position code in the field of view of the camera system 206. The control unit 210 is configured to compensate for this effect. If the pen is held such that the pen point is just outside a base or just outside a position-coded area of a base, whereas the field of view of the camera system is on the position-coded area of the base, the offset-compensated position will lie in the above-mentioned pattern page margin.

The electronic pen of FIG. 5 may operate as follows to record pen strokes by means of the above-described exemplary position code. When the contact sensor senses that pen tip is put down on a base, the camera system is triggered to capture images of the base close to the pen tip. The position code in each image is decoded to a position by localizing the symbols in the image, fitting a raster to the symbols, determining the direction of displacements of the symbols from the nominal positions defined by the raster line intersections and calculating the position based on the displacements of the symbols. For a more detailed description of how the different steps of the position decoding can be carried for this kind of position code, it is referred to e.g. U.S. Pat. No. 6,667,695 and US 2002/0044138, which is hereby incorporated by reference.

Each absolute global position decoded from the position code may then converted to a page address and a local x/y coordinate, which may be coded by a maximum of 16 bits, where each coordinate unit may be 0.0375 mm.

Before storing the coordinate data as pen strokes, a coordinate reduction step may be carried out. The coordinate reduction may for instance be based on the Douglas-Peucker algorithm. This reductions scheme removes coordinates with a deviation from a linear path that is lower than a predetermined threshold. The coordinate reduction is described in more detail in US 2003/0122802. The remaining coordinates may then be stored as Huffman-coded deviations from predicted positions to minimize the required storage space as is further described in US 2003/0123745.

The x/y coordinates of a pen stroke may be stored together with one or more of a time stamp indicating a reference time for the pen stroke, a session identifier, which is indicative of the pen working session during which the pen stroke has been recorded and which e.g. is incremented each time the pen is switched on, a force value for each coordinate indicating the force with which the pen point was pressed against the base when recording that coordinate, and a page address of the pattern page from which the pen stroke was recorded.

The thus-stored pen strokes may later on be incorporated in e.g. a HTTP request or a file object and transferred to an application server. The proprietary Stroke Transport Format essentially includes the session identifier, the x/y-coordinates, the time stamp and the force values together with header information.

The embodiment of the pen described in connection with FIG. 5 is just an example of an electronic pen that can be used for recording pen strokes. In another embodiment, the pen may have a subset of the above-mentioned components and/or partly or wholly other components or partly or wholly other design. Any software and hardware of the pen may need to be adapted to the specific way in which pen strokes are recorded. Also, the pen may record pen strokes in other ways than using a position-coded base. In one embodiment, the pen may determine its absolute position on a non-encoded surface by imaging the whole surface or part thereof and calculating its position with the aid of one or more of edges of the surface, corners of the surface or features of the surface. In another embodiment, the pen may determine its position by triangulation. In yet another embodiment, the digital pen may include one or more accelerometers and/or gyroscopes. Combinations of different positioning technologies may also be used, e.g. a combination of technologies using absolute and relative positioning.

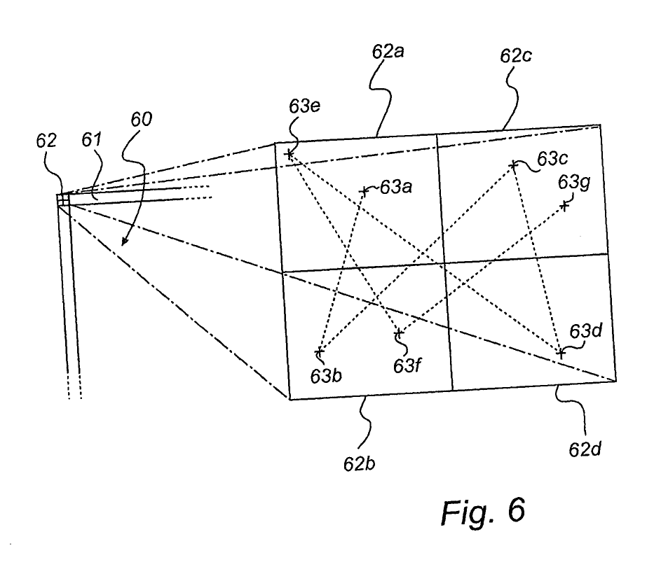

In the following an example of the coding of non-pen stroke data as pen stroke data will be described more in detail with reference to FIG. 6. In this example the coding process is carried out in the electronic pen 2. More particularly, the coding process may be carried out in a coding module, which receives non-pen stroke data as an input and which outputs pen stroke-coded non-pen stroke data as an output.

To the left, FIG. 6 schematically shows part of a logical pattern page 60 with a margin 61. In this embodiment the 32*32 coordinate area 62 of the upper left corner of the pattern page 60 is reserved for pen stroke-coded non-pen stroke data. This area 62 is divided into four quadrants 62a-62d, each one of 16*16 dots, for reasons that will be evident below. The four quadrants are shown in enlarged scale to the right in FIG. 6.

The pen may record non-pen stroke data by its camera system 206, or by a separate sensor. It may be set in a non-pen stroke data mode by the user or it may automatically by itself recognize that it is recording non-pen stroke data. In this embodiment it is assumed that the non-pen stroke data is binary data or converted to binary data.

Upon receipt of binary non-pen stroke data, the pen converts each byte of the binary data to x/y coordinate data as follows:

x-coordinate=(byte mod 16)+16*(int((coordinate index mod 4)/2))

y-coordinate=(byte/16)+16*(coordinate index mod 2)

where coordinate index indicates the ordinal number of the x/y coordinate(byte) in a sequence of x/y coordinates (bytes), “int” stands for “integer part of” and “mod” stands for “modulo”. Thus, the four least significant bits of a non-pen stroke data byte will be coded as an x-coordinate, whereas the four most significant bits thereof will be coded as a y-coordinate.

With this encoding the x/y coordinates are sequentially placed in each one of the quadrants 62a-62d as is shown in the enlarged part of FIG. 6, where the crosses 63a-63g represent seven x/y coordinates and the broken line connecting the coordinates represent the corresponding stroke. The number of bytes of data defines the length of the “stroke” in the 32 by 32 coordinate area.

If more data bits need be coded in each position, the size of the quadrants can be increased.

One reason for placing the coordinates sequentially in the four quadrants of the position area 62 may be to make sure that the coordinates are ineligible for coordinate reduction by preventing any three successive coordinates from forming a straight line. Another reason may be to qualify the stroke as a stroke which includes non-pen stroke data.

It may be beneficial to indicate which type of data is coded in the margin stroke, e.g. barcode data or keyboard data. To this end the coding process may add a first byte of data indicating the kind of data to the sequence of data to be coded in the margin. This first byte may be converted in the same manner as the data to an x/y coordinate which may be placed first in the sequence of x/y coordinates.

When the binary data has been converted to a sequence of x/y coordinates, this sequence of coordinates may be stored and processed in exactly the same way as an ordinary pen stroke.

It should however be kept in mind that, unlike ordinary pen strokes, non-pen stroke data may not in itself be associated with a specific pattern page, because it is typically recorded by means of other parameters than the position code. However, the non-pen stroke data may appear on a base having a position-coded area, like in FIG. 1. In such a case, the non-pen stroke data may be intended to be combined with pen stroke data recorded from the position-coded area in an application at the receiver side of the transfer system. The information management system may also route pen stroke data on the basis of page addresses. To this end, the non-pen stroke data may be associated with a pattern page which is selected according to a predetermined rule. This page may be e.g. the page on which the immediate following ordinary pen stroke is made, or the page on which the immediate previous ordinary pen stroke was made or a predetermined page or a page selected in any other suitable way.

When the pen stroke-coded non-pen stroke data is received at the receiving side of the system, e.g. in the application server 6 of FIG. 1, it is recognized as being non-pen stroke data as a result of the coordinate area to which the coordinates belong. Before the coordinates are decoded to binary data, they are all translated to a coordinate in the first quadrant 62a. This is carried out as follows:

x-coordinate(q1)=x-coordinate(qi)−16*(int(coordinate index mod 4/2))

y-coordinate(q1)=y-coordinate(qi)−16*(coordinate index mod 2)

where q1 is quadrant 1, qi is quadrant i for i=1, 2, 3, 4, “int” stands for “integer part of” and “mod” stands for “modulo”.

Then the resulting quadrant 1 coordinates are decoded to binary data as follows:

Byte=16(y-coordinate mod 16)+x-coordinate mod 16)

An advantage of using the corner area of the margin is that the pen stroke-coded non-pen strokes will not cross the position-coded area outside the margin and will thus not be rendered on the application side since pen strokes in the margin are typically not rendered. Furthermore, the corner area will be present even if the pattern page size is very small.

Evidently the use of the corner area is but an example. Other margin areas may also be used. One example would be to use a 4096*16 coordinate area in the upper margin and a 16*4096 coordinate area in the left margin and to alternatingly code bytes or other chunks of data as positions in these two coordinate areas. Also areas corresponding to position areas that may be used on a base could be used for transferring non-pen stroke data, provided that such areas are invalid for ordinary pen strokes in the system. In one embodiment different areas are dedicated to different types of non-pen stroke data.

Other schemes for coding non-pen stroke data to coordinates may also be used.

It is clear from above that the pen may under certain circumstances generate ordinary pen positions in the margin of the pattern page. Such pen stroke positions may be filtered off in the pen in order not to disturb the transfer on non-pen stroke data. If they are not filtered off at the sender side, they can be removed at the receiver side. The receiving unit may e.g. recognize such pen stroke positions from their relation to previous or subsequent positions.

It should be emphasized that the position code described above is just an example. Other kinds of position codes coding fewer positions and having the origin on the base could also be used.

The idea of transferring non-pen stroke data as pen stroke data through a transfer system designed for the transfer of pen stroke data may be utilized in information management systems other than those exemplified above. Such other information management systems may e.g. use other kinds of position codes or other technologies for recording pen strokes, other electronic pens, other pen stroke transport formats and/or other communication methods/transfer systems than the ones exemplified above.

In the embodiment above, the position area to which the positions of the non-pen stroke data belong is used as a characteristic enabling pen-stroke coded non-pen stroke data to be distinguished from ordinary pen stroke data. Other characteristics can also be used. The pen-stroke coded non-pen stroke data can e.g. be transferred together with a time stamp that is invalid, e.g. a time stamp indicating 0 as a reference time for the pen stroke. It could also be transferred on a specific pattern page dedicated for the transfer of non-pen stroke data.

In the embodiment above, the non-pen stroke data is transferred as separate pen strokes which are distinguishable from ordinary pen strokes. As an alternative the ordinary pen strokes may be used for transferring non-pen stroke data, e.g. by dedicating the least significant bit in each position indication in the ordinary pen strokes to the transfer of non-pen stroke data.

1. A method at the sender side of a transfer system designed for the transfer of pen stroke data, comprising
receiving non-pen stroke data;
coding the non-pen stroke data as pen stroke data using a predetermined reversible coding process before transferring the pen-stroke coded non-pen stroke data via the transfer system to a receiving unit.

2. A method as claimed in claim 1, wherein the pen stroke-coded non-pen stroke data is provided with a characteristic enabling non-pen stroke data to be distinguished from pen stroke data.

3. A method as claimed in claim 1 or 2, further comprising associating the pen stroke-coded non-pen stroke data with an identifier identifying a part area of a position-coding pattern which is divided into a plurality of part areas.

4. A method as claimed in claim 1, wherein the transfer system is designed for the transfer of pen stroke data in the form of position indications and wherein the non-pen stroke data is coded as at least one position indication indicating a position within a predetermined position area dedicated to pen stroke-coded non-pen stroke data.

5. A method as claimed in claim 4, wherein the pen stroke data represents pen strokes made by an electronic pen on a base and wherein the predetermined position area is a position area which is invalid for pen strokes made by the electronic pen.

6. A method as claimed in claim 1, wherein the receiving and the coding are carried out in an electronic pen, which is configured to record pen stroke data in the form of position indications from a position-coded base and to record non-pen stroke data from the same or another base.

7. A method as claimed in claim 1, wherein the transfer system is designed to compress pen stroke data before transfer and wherein the coding is carried out in such a way to make the pen stroke coded non-pen stroke data ineligible for compression.

8. A device at the sender side of a transfer system designed for the transfer of pen stroke data to a receiving unit, comprising a processing unit which is adapted to carry out the method according to claim 1.

9. A device as claimed in claim 8, wherein said device is an electronic pen, which is configured to record pen stroke data in the form of position indications from a position-coded base and to record non-pen stroke data from the same or another base.

10. A device as claimed in claim 9, wherein the electronic pen has a sensor which is used for the recording of both pen stroke data and non-pen stroke data.

11. A method at the receiving side of a transfer system designed for the transfer of pen stroke data, comprising
receiving pen stroke data from the transfer system; and
decoding non-pen stroke data from the pen stroke data using a predetermined decoding process.

12. A method as claimed in claim 11, further comprising identifying pen stroke data which codes non-pen stroke data.

13. A method as claimed in claim 11 or 12, wherein the pen stroke data is in the form of position indications and wherein the identifying comprises identifying at least one position indication indicating a position within a predetermined position area dedicated to pen stroke-coded non-pen stroke data.

14. A device at the receiving side of a transfer system designed for the transfer of pen stroke data, comprising a processing unit which is adapted to carry out the method according to claim 11.
